(19) United States
(12) Patent Application Publication
(10) Pub. No.: US 2025/0340368 A1
(43) Pub. Date: Nov. 6, 2025

(54) CALIBRATION AND ALIGNMENT SETUP OF CONTAINER RECOGNITION USING CONTAINERS

(71) Applicant: Oshkosh Corporation, Oshkosh, WI (US)

(72) Inventors: Leo Van Kampen, Conestogo (CA); Vince Schad, Oshkosh, WI (US); Paul Leedle, Oshkosh, WI (US)

(73) Assignee: Oshkosh Corporation, Oshkosh, WI (US)

(21) Appl. No.: 19/197,293

(22) Filed: May 2, 2025

Related U.S. Application Data
(60) Provisional application No. 63/642,169, filed on May 3, 2024.

(51) Int. Cl. B65F 3/04; B65F 3/02

(52) U.S. Cl. CPC B65F 3/041; B65F 2003/023; B65F 2003/0269

(57) ABSTRACT

A control system for a refuse vehicle includes at least one proximity sensor to sense proximity of a target waste receptacle positioned relative to the refuse vehicle and processing circuitry. The processing circuity is configured to register a perpendicular distance between an edge of the target waste receptacle and a portion of the refuse vehicle, register a first lateral position of the target waste receptacle when the target waste receptacle is at the perpendicular distance, register a second lateral position of the target waste receptacle when the target waste receptacle is at the perpendicular distance, define a sensing range based on the first lateral position and the second lateral position, and store the perpendicular distance and the sensing range in a memory. The processing circuity is configured to repeat the preceding steps for each of a first position, second position, third position, and fourth position of the target waste receptacle.

### CROSS-REFERENCE TO RELATED APPLICATIONS

This application claims the benefit of and priority to U.S. Provisional Application No. 63/642,169, filed on May 3, 2024, the entire disclosure of which is hereby incorporated by reference herein.

### BACKGROUND

The present disclosure relates generally to control systems for refuse vehicles. More particularly, the present disclosure relates to methods of calibrating cart detection systems.

### SUMMARY

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

At least one aspect of the present disclosure relates to a control system for a refuse vehicle. The system includes at least one proximity sensor configured to sense a proximity of a target waste receptacle positioned relative to a lift apparatus of the refuse vehicle. The system further includes processing circuitry configured to register a perpendicular distance between an edge of the target waste receptacle and a portion of the refuse vehicle, register a first lateral location of the target waste receptacle when the target waste receptacle is at the perpendicular distance, register a second lateral location of the target waste receptacle when the target waste receptacle is at the perpendicular distance, define a sensing range based on the first lateral location and the second lateral location, store the perpendicular distance and the sensing range in a memory, and repeat registering the perpendicular distance, the first lateral location, and the second lateral location for each of a first position, second position, third position, and fourth position of the target waste receptacle.

In various embodiments, the at least one proximity sensor is a light detection and ranging (LiDAR) sensor. In some embodiments, the perpendicular distance corresponding to the first position is 30 inches. In other embodiments, the perpendicular distance corresponding to the second position is 100 inches. In yet other embodiments, the perpendicular distance corresponding to the third position is zero inches. In various embodiments, the perpendicular distance corresponding to the fourth position is 78 inches. In some embodiments, the processing circuitry is further configured to initiate registering the perpendicular distance between an edge of the target waste receptacle and a portion of the refuse vehicle responsive to an input received from at least one controller within the refuse vehicle. In other embodiments, the input corresponds to a calibration procedure.

Another aspect of the present disclosure relates to a refuse vehicle. The refuse vehicle includes an arm structured to collect a waste receptacle, at least one sensor structured to sense a proximity of the waste receptacle, and at least one processor communicatively coupled to the arm and the at least one sensor, the at least one processor configured to carry out a calibration setup. Carrying out the calibration setup includes registering a perpendicular distance between an edge of the waste receptacle and a portion of the refuse vehicle, registering a first lateral location of the waste receptacle when the waste receptacle is at the perpendicular distance, registering a second lateral location of the waste receptacle when the waste receptacle is at the perpendicular distance, defining a sensing range based on the first lateral location and the second lateral location, storing the perpendicular distance and the sensing range in a memory, and repeating registering the perpendicular distance, the first lateral location, and the second lateral location for a plurality of positions corresponding to the waste receptacle.

In various embodiments, the plurality of positions includes four predetermined positions. In some embodiments, each of the first lateral location and the second lateral location are determined in a direction parallel to a length of the refuse vehicle. In other embodiments, when the waste receptacle is in a first position of the four predetermined positions, a sensing line of the at least one sensor is aligned with a first side of the waste receptacle. In yet other embodiments, when the waste receptacle is in a second position of the four predetermined positions, the sensing line of the at least one sensor is aligned with a first side of the waste receptacle, and wherein the perpendicular distance at the first position is smaller than the perpendicular distance at the second position. In various embodiments, the refuse vehicle further includes a grasping mechanism coupled to the arm, and wherein when the waste receptacle is in a third position of the four predetermined positions, a front end of the waste receptacle is disposed adjacent to the grasping mechanism. In yet other embodiments, when the waste receptacle is in the third position, the waste receptacle is laterally centered between outer ends of the grasping mechanism. In various embodiments, when the waste receptacle is in a fourth position of the four predetermined positions, the waste receptacle is laterally centered between ends of the grasping mechanism. In some embodiments, the at least one processor is further configured to determine a pick-up zone corresponding to the waste receptacle based on the calibration setup. In other embodiments, the refuse vehicle further includes least one controller, wherein registering the perpendicular distance, the first lateral location, and the second lateral location for a plurality of positions corresponding to the waste receptacle are carried out via the at least one controller. In some embodiments, the at least one controller is a joystick. In yet other embodiments, the at least one sensor is a light detection and ranging (LiDAR) sensor.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic representation of a system for detecting and repositioning a waste receptacle, according to at least one embodiment.

FIG. 2 is a pictorial representation of a waste receptacle and template representation associated with the waste receptacle, according to some embodiments.

FIG. 3 is a flow diagram depicting a method for creating a representation of an object, according to some embodiments.

FIG. 4 is a network diagram showing a system for detecting and picking up a waste receptacle, according to some embodiments.

FIG. 5 is a flow diagram depicting a method pipeline used to detect and locate a waste receptacle, according to some embodiments.

FIG. 6 is a flow diagram depicting an example of a modified Line2D gradient-response map method, according to some embodiments.

FIG. 7 is a pictorial representation of the verify candidate step of a method for detecting and locating a waste receptacle, according to some embodiments.

FIG. 8 is a flow diagram depicting a method for detecting and picking up a waste receptacle, according to some embodiments.

FIG. 9 is a flow diagram depicting a method of calibrating the system of FIG. 1, according to at least one embodiment.

FIG. 10 is a top view of the system of FIG. 1 when the vehicle is in a first position, according to at least one embodiment.

FIG. 11 is a perspective view of the system of FIG. 10 near a proximity sensory, according to at least one embodiment.

FIG. 12 is a top view of the system of FIG. 1 when the receptacle is in a first position, according to at least one embodiment.

FIG. 13 is a schematic representation of a graphical user interface within the system of FIG. 1, according to at least one embodiment.

FIG. 14 is a front perspective view of a controller within the system of FIG. 1, according to at least one embodiment.

FIG. 15 is a top view of the system of FIG. 1 when the receptacle is in the first position, according to at least one embodiment.

FIGS. 16-17 are side and perspective views, respectively, of a proximity sensor within the system of FIG. 1, according to at least one embodiment.

FIG. 18 is a top view of the system of FIG. 1, when the receptacle is in a second position, according to at least one embodiment.

FIG. 19 is a perspective view of the system of FIG. 1, when the receptacle is in a third position, according to at least one embodiment.

FIG. 20 is a top view of the system of FIG. 1, when the receptacle is in a fourth position, according to at least one embodiment.

FIG. 21 is a schematic representation of the system of FIG. 1 illustrating placement of the receptacle within each of the first, second, third, and fourth positions, according to at least one embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the Figures, a detection and warning system (e.g., an alert system, a control system, etc.) is configured to obtain image data of a lift apparatus (e.g., a lift assembly, a grabber assembly, an arm, a track, etc.) of a refuse vehicle and a target waste receptacle. The lift apparatus may be configured to grasp the waste receptacle when operated. However, if the lift apparatus and the waste receptacle are not properly aligned, the lift apparatus may knock or tip over the waste receptacle, therefore requiring the operator of the refuse vehicle to exit the cabin of the refuse vehicle, and pick up the spilled waste. The detection and warning systems described herein are configured to mitigate issues associated with misalignment of the lift apparatus by determining, based on the image data, whether the current arrangement of the lift apparatus is likely to cause the waste receptacle to tip or fall over when engaged by the lift apparatus. In some embodiments, the detection and warning systems include a controller that is configured to obtain the image data and uses the image data and to predict if operation of the lift apparatus will knock over the waste receptacle. The controller can operate an alert system (e.g., warning lights, flashers, speakers, a display screen, etc.) to notify the operator that the lift apparatus is predicted to knock over the waste receptacle. The controller may also limit operation of the lift apparatus if the lift apparatus is predicted to knock over the waste receptacle.

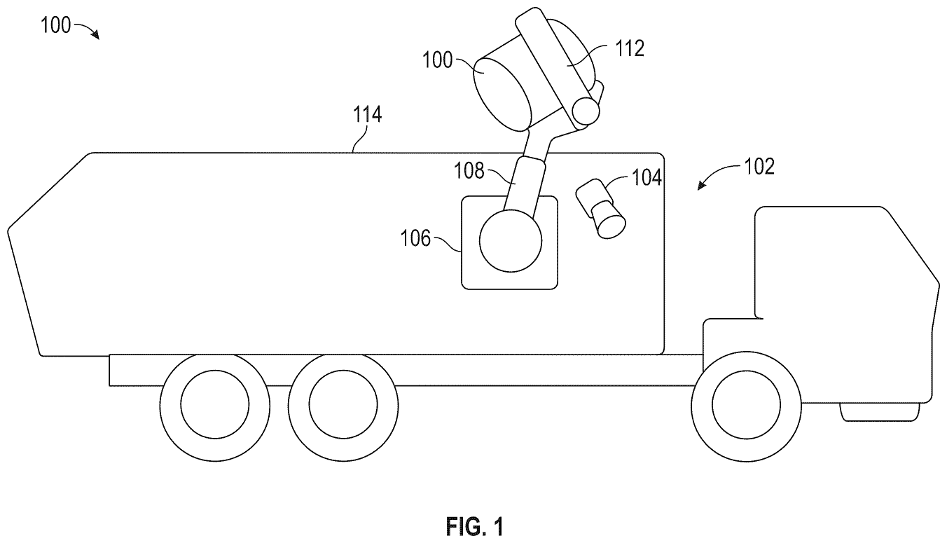

Referring to FIG. 1, there is a system 100 for detecting and picking up a waste receptacle. The system 100 comprises a camera 104, an arm-actuation module 106, and an arm 108 for collecting the waste from a waste receptacle 110. According to some embodiments, the system 100 can be mounted on a waste-collection vehicle 102 (e.g., a refuse vehicle, a waste collection vehicle, a commercial vehicle, a vehicle with a lift apparatus, etc.). When the camera 104 detects the waste receptacle 110, for example along a curb, arm-actuation module 106 moves the arm 108 so that the waste receptacle 110 can be dumped into the waste-collection vehicle 102.

A waste receptacle is a container for collecting or storing garbage, recycling, compost, and other refuse, so that the garbage, recycling, compost, or other refuse can be pooled with other waste, and transported for further processing. Generally, waste may be classified as residential, commercial, industrial, etc. As used here, a “waste receptacle” may apply to any of these categories, as well as others. Depending on the category and usage, a waste receptacle may take the form of a garbage can, a dumpster, a recycling “blue box”, a compost bin, etc. Further, waste receptacles may be used for curb-side collection (e.g., at certain residential locations), as well as collection in other specified locations (e.g., in the case of dumpster collection).

The camera 104 is positioned on the waste-collection vehicle 102 so that, as the waste-collection vehicle 102 is driven along a path, the camera 104 can capture real-time images adjacent to or in proximity of the path.

The arm 108 is used to grasp and move the waste receptacle 110. The particular arm that is used in any particular embodiment may be determined by such things as the type of waste receptacle, the location of the arm 108 on the waste-collection vehicle, etc.

The arm 108 is generally movable, and may comprise a combination of telescoping lengths, flexible joints, etc., such that the arm 108 can be moved anywhere within a three-dimensional volume that is within range of the arm 108.

According to some embodiments, the arm 108 may comprise a grasping mechanism 112 for grasping the waste receptacle 110. The grasping mechanism 112 may include any combination of mechanical forces (e.g., friction, compression, etc.) or magnetic forces to grasp the waste receptacle 110.

The grasping mechanism 112 may be designed for complementary engagement with a particular type of waste receptacle 110. For example, to pick up a cylindrical waste receptacle, such as a garbage can, the grasping mechanism 112 may comprise opposed fingers, or circular claws, etc., that can be brought together or cinched around the garbage can. In other cases, the grasping mechanism 112 may comprise arms or levers for complementary engagement with receiving slots on the waste receptacle.

Generally, the grasping mechanism 112 may be designed to complement a specific waste receptacle, a specific type of waste receptacle, a general class of waste receptacles, etc.

The arm-actuation module 106 is generally used to mechanically control and move the arm 108, including the grasping mechanism 112. The arm-actuation module 106 may comprise actuators, pneumatics, etc., for moving the arm. The arm-actuation module 106 is electrically controlled by a control system for controlling the movement of the arm 108. The control system can provide control instructions to the arm-actuation module 106 based on the real-time images captured by the camera 104.

The arm-actuation module 106 controls the arm 108 to pick up the waste receptacle 110 and dump the waste receptacle 110 into the bin 114 of the waste-collection vehicle 102. To accomplish this, the control system that controls the arm-actuation module 106 verifies whether a pose candidate derived from an image captured by the camera 104 matches a template representation corresponding to a target waste receptacle.

However, in order to be able to verify whether a pose candidate matches a template representation, the template representation must first be created. First, it is necessary to create template representations. Second, the template representations can be used to verify pose candidates based on real-time images. Pose candidates will be described in further detail below, after the creation of template representations is described.

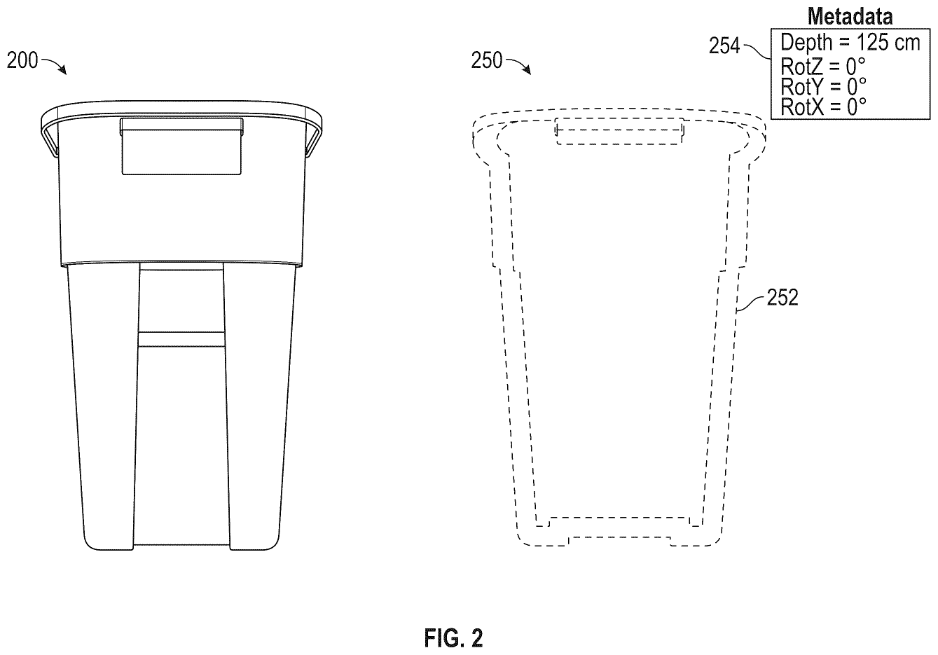

Referring to FIG. 2, there is shown an example of a waste receptacle 200 and a template representation of a single pose 250 created in respect of the waste receptacle 200.

The template representation 250 is created by capturing multiple images of the object 200. These multiple images are captured by taking pictures at various angles and scales (depths) around the object 200. When a sufficient number of images have been captured for a particular object 200, the images are processed.

The final product of this processing is the template representation 250 associated with the object 200. In particular, the template representation 250 comprises gradient information data 252 and pose metadata 254. The complete object representation consists of a set of templates, one for each pose.

The gradient information 252 is obtained along the boundary of the object 200 as found in the multiple images. The pose metadata 254 are obtained from the pose information, such as the angles and scales (depths) at which each of the multiple images was captured. For example, the template representation 250 is shown for a depth of 125 cm, with no rotation about the X, Y, or Z axes.

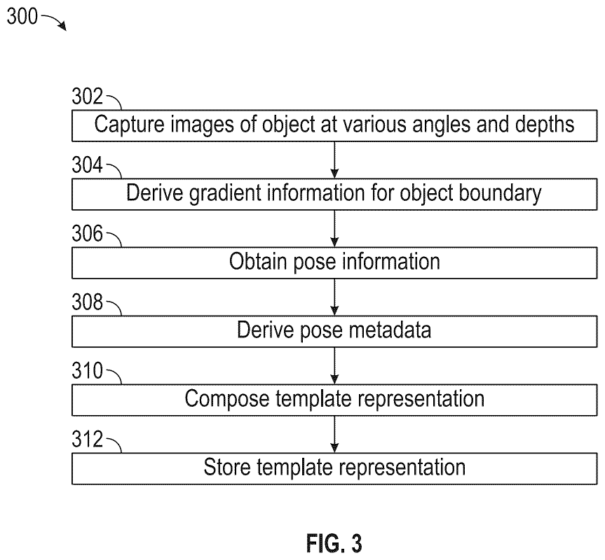

Referring to FIG. 3, there is shown a method 300 for creating a representation of an object.

The method begins at step 302, when images of an object are captured at various angles and scales (depths). The images are captured by taking pictures of an object, such as the waste receptacle 200, at various angles and scales (depths). Each image is associated with pose information, such as the depth, and the three-dimensional position and/or rotation of the camera in respect of a reference point or origin.

At step 304, gradient information is derived for the object boundary for each image captured. For example, as seen in FIG. 2, the gradient information is represented by the gradient information data 252. As can be seen, the gradient field comprising the gradient information data 252 corresponds to the boundaries (edges) of the waste receptacle 200.

At step 306, pose information associated with each image is obtained. For example, this may be derived from the position of the camera relative to the object, which can be done automatically or manually, depending on the specific camera and system used to capture the images.

At step 308, pose metadata are derived based on the pose information associated with each image. The pose metadata are derived according to a prescribed or pre-defined format or structure such that the metadata can be readily used for subsequent operations such as verifying whether a pose candidate matches a template representation.

At step 310, a template representation is composed using the gradient information and pose metadata that were previously derived. As such, a template representation comprises gradient information and associated pose metadata corresponding to each image captured.

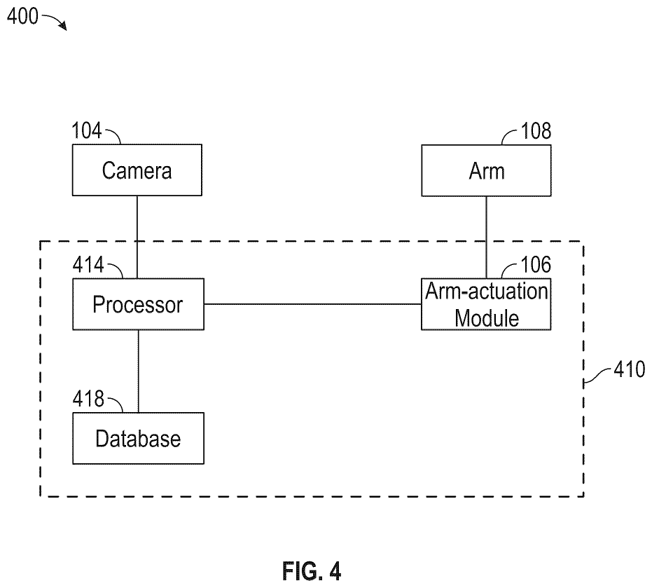

At step 312, the template representation is stored so that it can be accessed or transferred for future use. Once the template representations have been created and stored, they can be used to verify pose candidates derived from real-time images, as will be described in further detail below. According to some embodiments, the template representations may be stored in a database. According to some embodiments, the template representations (including those in a database) may be stored on a non-transitory computer-readable medium. For example, the template representations may be stored in database 418, as shown in FIG. 4, and further described below.

Referring to FIG. 4, there is shown a system 400 for detecting and picking up a waste receptacle. The system comprises a control system 410, a camera 104, and an arm 108. The control system 410 comprises a processor 414, a database 418, and an arm-actuation module 106. According to some embodiments, the system 400 can be mounted on or integrated with a waste-collection vehicle, such as waste-collection vehicle 102.

In use, the camera 104 captures real-time images adjacent to the waste-collection vehicle as the waste-collection vehicles is driven along a path. For example, the path may be a residential street with garbage cans placed along the curb. The real-time images from the camera 104 are communicated to the processor 414. The real-time images from the camera 104 may be communicated to the processor 414 using additional components such as memory, buffers, data buses, transceivers, etc., which are not shown.

The processor 414 is configured to recognize a waste receptacle, based on an image that it receives from the camera 104 and a template representation stored in the database 418.

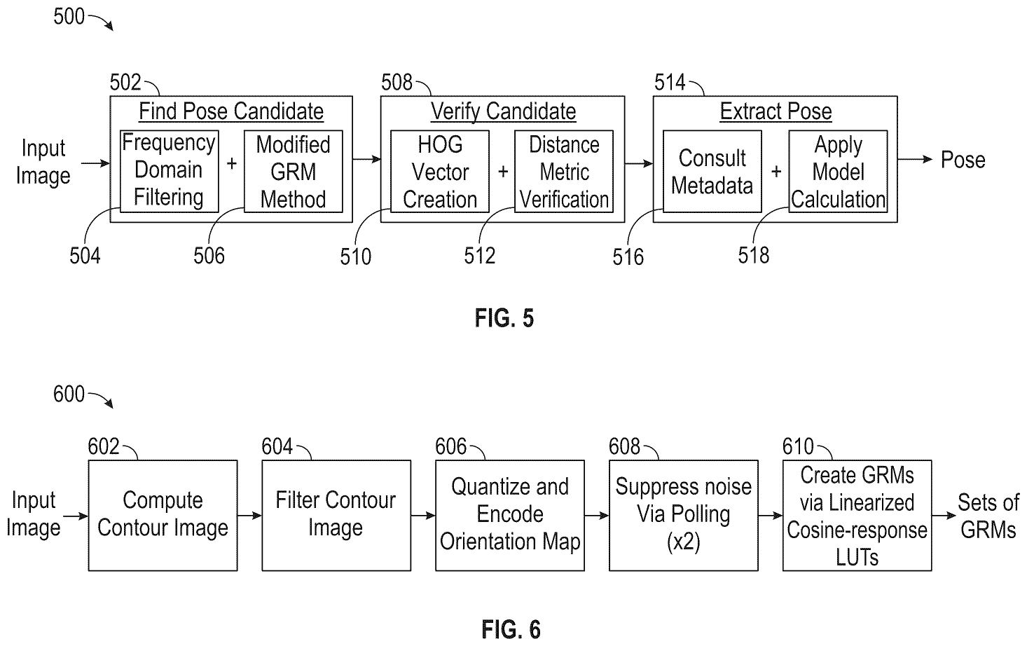

Referring to FIG. 5, a general method 500 for detecting and locating a waste receptacle is shown, such as can be performed by the processor 414. The method 500 can be described as including the steps of generating a pose candidate 502, verifying the pose candidate 508, and calculating the location of the recognized waste receptacle 514 (i.e., extracting the pose).

The generate a pose candidate step 502 can be described in terms of frequency domain filtering 504 and a gradient-response map method 506. The step of verifying the pose candidate 508 can be described in terms of creating a histogram of oriented gradients (HOG) vector 510 and a distance-metric verification 512. The extract pose step 514 (in which the location of the recognized waste receptacle is calculated) can be described in terms of consulting the pose metadata 516, and applying a model calculation 518. The step of consulting the pose metadata 516 generally requires retrieving the pose metadata from the database 418.

Referring to FIG. 6, there is shown a modified Line2D method 600 for implementing the generating pose candidate step 502. A Line2D method can be performed by the processor 414, and the instructions for a Line2D method may generally be stored in system memory (not shown).

A standard Line2D method can be considered to comprise a compute contour image step 602, a quantize and encode orientation map step 606, a suppress noise via polling step 608, and a create gradient-response maps (GRMs) via look-up tables (LUTs) step 610. In the method 600 as depicted, a filter contour image step 604 has been added as compared to the standard Line2D method. Furthermore, the suppress noise via polling step 608 and the create GRMs via LUTs step 610 have been modified as compared to the standard Line2D method.

The filter contour image step 604 converts the image to the frequency domain from the spatial domain, applies a high-pass Gaussian filter to the spectral component, and then converts the processed image back to the spatial domain. The filter contour image component 604 can reduce the presence of background textures in the image, such as grass and foliage.

The suppression of noise via polling step 608 is modified from a standard Line2D method by adding a second iteration of the process to the pipeline. In other words, polling can be performed twice instead of once, which can help reduce false positives in some circumstances.

The create GRMs via LUTs step 610 is modified from a standard Line2D method by redefining the values used in the LUTs. Whereas a standard Line2D method may use values that follow a cosine response, the values used in the LUTs in the modified component 610 follow a linear response.

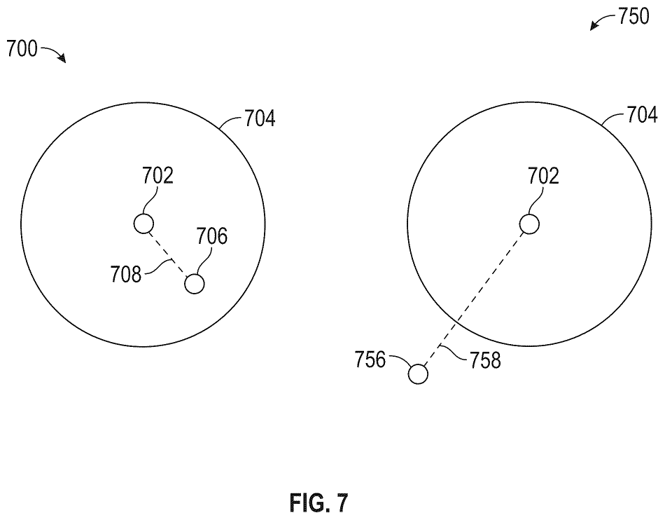

Referring to FIG. 7, there is shown a pictorial representation of the verify candidate step 508. Two examples are shown in FIG. 7. The first example 700 depicts a scenario in which a match is found between the HOG of the template representation and the HOG of the pose candidate. The second example 750 depicts a scenario in which a match is not found.

In each example 700 and 750, the HOG of a template representation 702 is depicted at the center of a circle that represents a pre-defined threshold 704.

Example 700 depicts a scenario in which the HOG of a pose candidate 706 is within the circle. In other words, the difference 708 (shown as a dashed line) between the HOG of the template representation 702 and the HOG of the pose candidate 706 is less than the pre-defined threshold 704. In this case, a match between the pose candidate and the template representation can be verified.

Example 750 depicts a scenario in which the HOG of a pose candidate 756 is outside the circle. In other words, the difference 758 between the HOG of the template representation 702 and the HOG of the pose candidate 756 is more than the pre-defined threshold 704. In this case, a match between the pose candidate and the template representation cannot be verified.

Referring again to FIG. 5, when a match between the pose candidate and the template representation has been verified at step 508, the method 500 proceeds to the extract pose step 514. This step exploits the pose metadata stored during the creation of the template representation of the waste receptacle. This step calculates the location of the waste receptacle (e.g., the angle and scale). The location of the waste receptacle can be calculated using the pose metadata, the intrinsic parameters of the camera (e.g., focal length, feature depth, etc.), and a pin- hole model.

Referring again to FIG. 4, once the location of the waste receptacle has been calculated, the arm-actuation module 106 can be used to move the arm 108 according to the calculated location of the waste receptacle. According to some embodiments, the processor 414 may be used to provide control instructions to the arm-actuation module 106. According to other embodiments, the control signals may be provided by another processor (not shown), including a processor that is integrated with arm-actuation module 106.

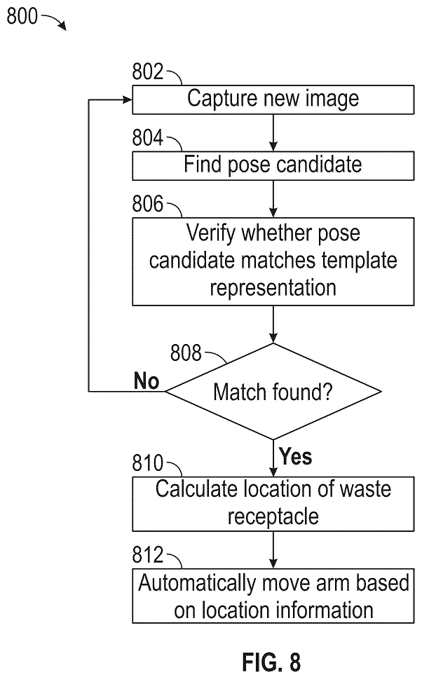

Referring to FIG. 8, there is shown a method for detecting and picking up a waste receptacle. The method begins at 802, when a new image is captured. For example, the new image may be captured by the camera 104, mounted on a waste-collection vehicle as it is driven along a path. According to some embodiments, the camera 104 may be a video camera, capturing real-time images at a particular frame rate.

At 804, the method finds a pose candidate based on the image. For example, the method may identify a waste receptacle in the image.

According to some embodiments, step 804 may include the steps of filtering the image and generating a set of gradient-response maps. For example, filtering the image may be accomplished by converting the image to the frequency domain, obtaining a spectral component of the image, applying a high-pass Gaussian filter to the spectral component, and then returning the image back to its spatial representation.

According to some embodiments, step 804 may include a noise suppression step. For example, noise can be suppressed via polling, and, in particular, superior noise-suppression results can be obtained by performing the polling twice (instead of once).

At 806, the method verifies whether the pose candidate matches the template representation. According to some embodiments, this is accomplished by comparing an HOG of the template representation with an HOG of the pose candidate. The difference between the HOG of the template representation and the HOG of the pose candidate can be compared to a pre-defined threshold such that, if the difference is below the threshold, then the method determines that a match has been found; and if the difference is above the threshold, then the method determines that a match has not been found.

At 808, the method queries whether a match between the pose candidate and the template representation during the previous step at 806. If a match is not found—i.e., if the waste receptacle (or other target object) was not found in the image-then the method returns to step 802, such that a new image is captured, and the method proceeds with the new image. If, on the other hand, a match is found, then the method proceeds to step 810.

At step 810, the location of the waste receptacle is calculated. According to some embodiments, the location can be determined based on the pose metadata stored in the matched template representation. For example, once a match has been determined at step 808, then, effectively, the waste receptacle (or another target object) has been found. Then, by querying the pose metadata associated with the matched template representation, the particular pose (e.g., the angle and scale or depth) can be determined.

At step 812, the arm 108 is automatically moved based on the location information. The arm may be moved via the arm-actuation module 106.

According to some embodiments, the arm 108 may be moved entirely automatically. In other words, the control system 410 may control the precise movements of the arm 108 necessary for the arm 108 to grasp the waste receptacle, lift the waste receptacle, dump the waste receptacle into the waste-collection vehicle, and then return the waste receptacle to its original position, without the need for human intervention.

According to other embodiments, the arm 108 may be moved automatically towards the waste receptacle, but without the precision necessary to move the waste receptacle entirely without human intervention. In such a case, the control system 410 may automatically move the arm 108 into sufficient proximity of the waste receptacle such that a human user is only required to control the arm 108 over a relatively short distance to grasp the waste receptacle. In other words, according to some embodiments, the control system 410 may move the arm 108 most of the way towards a waste receptacle by providing gross motor controls, and a human user (e.g., using a joystick control), may only be required to provide fine motor controls.

In various embodiments, the control system 410 can be configured to carry out one or more operations to calibrate the system 100 prior to initiating in-field detection and collection of one or more waste receptacles 110. For example, in various embodiments, the system 100 can include one or more proximity sensors (instead of or in addition to the at least one camera 104) disposed on the vehicle 102 to facilitate determining a position of the receptacle 110 relative to vehicle 102 and aid repositioning and collection of the receptacle 110. Accordingly, in some embodiments, the control system 410 can be configured to calibrate the one or more proximity sensors within the system 100 to verify sensed distances are sufficiently accurate.

In various embodiments, calibration of the system 100 is carried out by the control system 410 implementing one or more calibration algorithms. During operation, the control system 410 operates the system 100 using the cart recognition operations described above (e.g., by implementing the method 500), in addition to using inputs from at least one proximity sensor to determine the edge positions (e.g., top, bottom, lateral sides, front, etc.) of a receptacle 110 to be repositioned and/or collected (i.e., “cart measuring”). In various implementations, the center of the receptacle 100 within a bounding box in an image pixel is used as a reference to determine relevant horizontal points (e.g., lateral edges of the receptacle 110) and vertical points (e.g., top and bottom edges of the receptacle 110) in the proximity sensor measuring zones. As described below, to calibrate the system 100, the receptacle 110 can be first centered roughly within a known sensing range of the at least one proximity sensor (e.g., a single point LiDAR's beam). Moving the receptacle 110 to one side of sensing range can indicate a step increase in the sensor's reading. This step increase can indicate the edge of the receptacle 110 and a pixel location at this point can be saved (e.g., by the memory within the control system 410). The process can then be repeated for left and right of the sensing range, and close and far from the at least one sensor to get 4 points to define the left-side and right-side zones of the measuring range (i.e., “pick-up zone”) for the receptacle 110.

In various embodiments, tor the line determination of the “pick-up” zone, the center of the receptacle 110 can be aligned at approximately a same distance from the vehicle in this case as it was for determining the “cart measuring,” but only using the center positions. Using the same distance can result in a determine center of the “pick-up” zone. Accordingly, the same widths determined for the receptacle 110 during “cart measuring” can be used to modify the determined “pick-up” center line to define a positioning zone for the receptacle 110 (e.g., plus and minus ½ of the “cart measuring” width close and far). In some embodiments, both sets of zone lines (i.e., the “pick-up” zone and the “cart measuring” zone) can be altered by some multiplier to bias the zones wider or narrower than the receptacle 110.

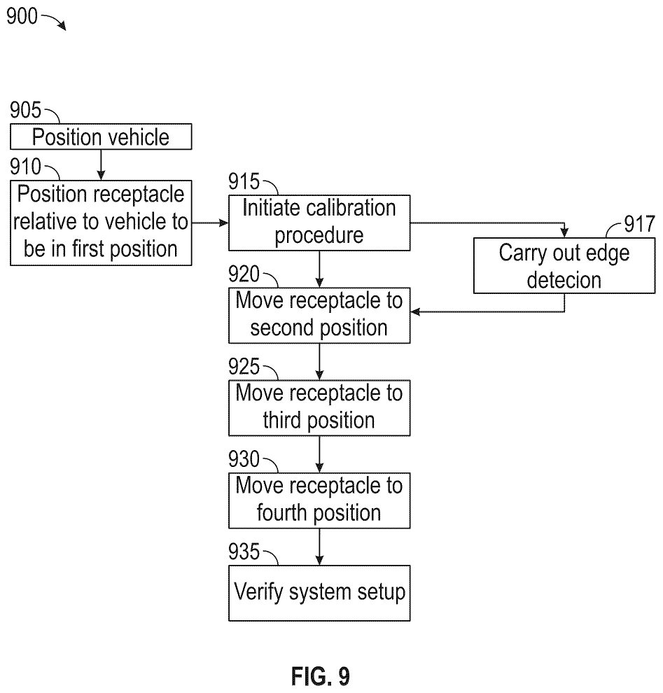

FIG. 9 shows a flow diagram of a method 900 for calibrating the system 100 (i.e., for calibrating the system 100 for determination of the pick-up zone corresponding to the receptacle 110). The method 900 begins with the step 905, in which the vehicle 102 can be positioned relative to the waste receptacle 110. After the vehicle 102 has been positioned, the receptacle 110 can be placed into a known first position relative to the vehicle 102 and its specific position and distance recorded by the control system 410 in a step 910. Once the receptacle 110 is in the first position, a calibration procedure can be initiated by the control system 410 in a step 915. Once the calibration procedure is initiated, the receptacle 110 can be relocated to a second position relative to the vehicle 102 and its specific position and distance recorded by the control system 410 in a step 920. In the step 925, the receptacle 110 can then be moved to a third position relative to the vehicle 102 and its specific position and distance recorded by the control system 410. Finally, in the step 930, the receptacle 110 can be moved to yet a fourth position relative to the vehicle 102 and its specific position and distance recorded by the control system 410. Once each of the first, second, third, and fourth positions have been recorded by the control system 410, the control system 410 (e.g., via the processor 414) can control the arm 108 in accordance with collecting the receptacle 110 from each of the first, second, third, and fourth positions to check for accuracy and verify the system 100 is adequately calibrated. The method 900, or any of the steps 905-935 therein, can be repeated as necessary to ensure adequate calibration of the system 100.

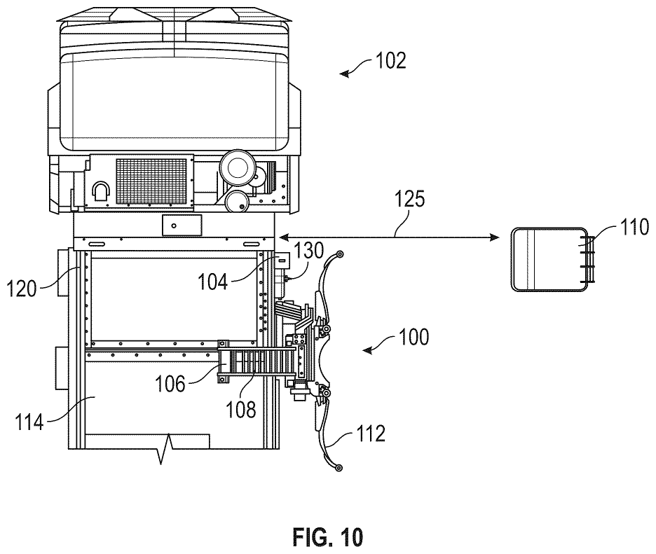

During the step 905, the vehicle 102 can be positioned a known distance 125 from the waste receptacle 110, as shown in FIG. 10. In various embodiments, in carrying out the step 905, the vehicle can be positioned on level ground with the receptacle 125 placed within the distance 125 from a front portion of a head frame 120 of the vehicle 120. In various embodiments, the distance is approximately 100 inches. In some embodiments, when the vehicle 102 is in position, the carriage of the vehicle 102 is at a lowest point (i.e., such that it rests on rubber pads at bottom of tracks). In some embodiments, the step 905 can also include manipulating the arm 108 and grasping mechanism 112 such that the arm 108 is fully retracted (i.e., is closest to the head frame 120) and the grasping mechanism 112 is maximally opened, such as shown in FIG. 10.

In various embodiments, as shown in FIG. 10, the system 100 can include at least one proximity sensor 130 coupled to the vehicle 102. For example, as shown in FIG. 10, the at least one proximity sensor 130 can be coupled to the head frame 120. In some embodiments, the at least one proximity sensor 130 can be disposed near a front corner of the head frame 120. In various embodiments, the at least one proximity sensor 130 can be a light detection and ranging (LiDAR) sensor. In other embodiments, the at least one sensor 130 can be a capacitive, photoelectric, or inductive sensor. In yet other embodiments, the at least one sensor 130 can be any suitable proximity sensor know in the art.

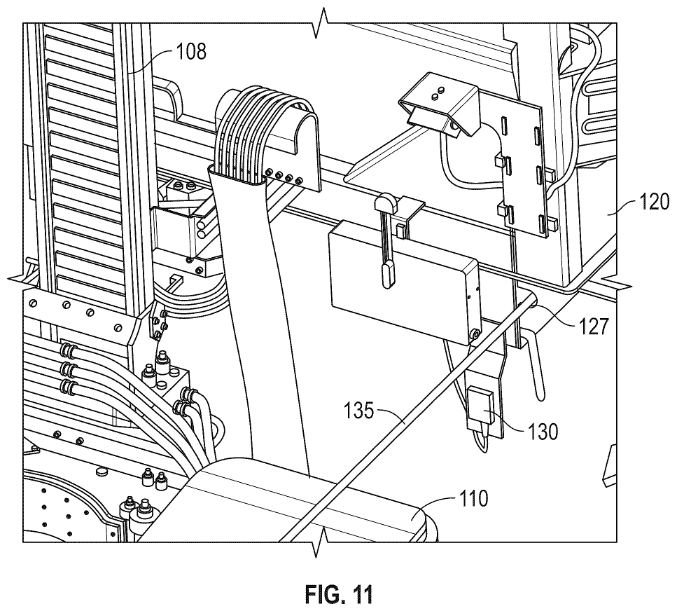

To verify distances (e.g., the distance 125) measured by the at least one sensor 130, in various embodiments, one or more measuring tools 135 (e.g., tape measure, digital distance sensor, etc.) can be used. For example, as shown in FIG. 11, one or more distances (e.g., the distance 125) between the receptacle 110 and the vehicle 102 can be manually measured and verified using a tape measure 135. In some implementations, the tape measure 135 (or other measuring tool) can be anchored (e.g., hooked) in one or more recesses 127 within the head frame 120 (e.g., hole adjacent to cleanout can), as shown in FIG. 11.

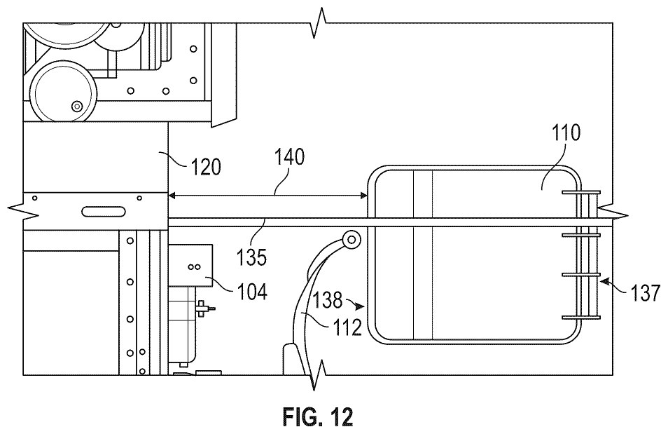

Once the vehicle 102 has been adequately positioned in the step 905, the receptacle 110 can be moved to the first position in the step 910. As shown in FIG. 12, the receptacle 110 can be placed in the first position such that a front edge 138 of the receptacle 110 is a known distance 140 from a side of the head frame 120. In some embodiments, the distance 140 is approximately 30 inches.

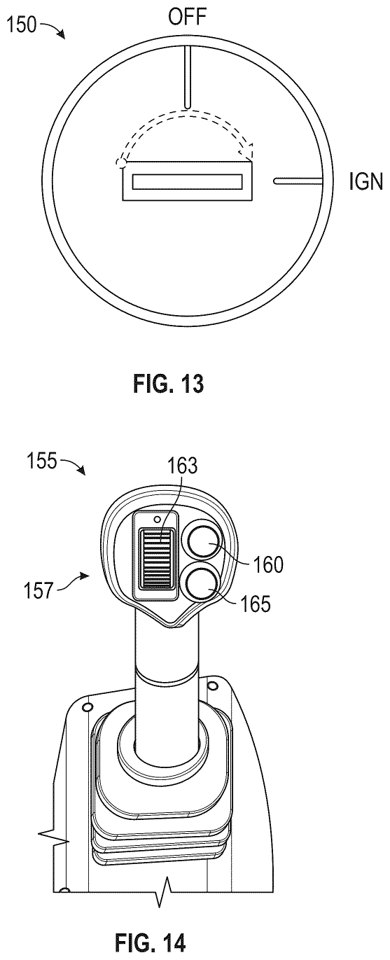

While the receptacle 110 is in the first position, the calibration procedure can be initiated in the step 915 by the control system 410. In various embodiments, the control system 410 can be configured to initiate the calibration procedure in response to input received from at least one controller within the vehicle 102. For example, with the vehicle 102 powered on (e.g., with the ignition on), the at least one controller can initiate the calibration procedure responsive to a user input. In various embodiments, once the calibration procedure is initiated in the step 915, one or more user interfaces within the vehicle 102 can provide one or more audible, visual, and/or haptic indications that the calibration procedure has been initiated. For example, as shown in FIG. 13, a user interface 150 can indicate the vehicle 102 is on and the calibration procedure is initiated.

To initiate the calibration procedure in the step 915, the at least one controller can receive one or more inputs. In some embodiments, the at least one controller can be a joystick, such as the joystick 155 shown in FIG. 14. In some embodiments, the joystick 155 includes a handle portion 157 having at least one first button 160 and at least one second button 165 disposed below the first button 160. In various embodiments, a user can initiate the calibration procedure in the step 915 by pressing the buttons 160 and 165 simultaneously and holding both for a period of time (e.g., 5 seconds). In other embodiments, the user can initiate the calibration procedure by pressing one of the buttons 160 or 165. In various embodiments, such as shown in FIG. 14, the joystick 155 can include at least one secondary input control 163, which can include a wheel, a lever, a slide control, a button, a switch, or any other suitable input control. The at least one secondary input control 163 can be configured to facilitate controlling the vehicle 102. In some embodiments, the at least one controller is a user interface (e.g., graphical user interface) disposed within the vehicle 102. In yet other embodiments, the at least one controller can be a remote controller (e.g., standalone controller, user device, etc.) disposed outside of the vehicle 102 but configured to control operations thereof.

Once the calibration procedure has been initiated in the step 915, the first position of the receptacle 110 can be confirmed (i.e., measured by the at least one sensor 130) and stored by the control system 410. In some embodiments, confirming the receptacle 110 is in the first position can be carried out via the at least one controller. For example, in some embodiments, a user can press one of the first button 160 or the second button 165 on the controller 155 that the receptacle 110 is in the first position.

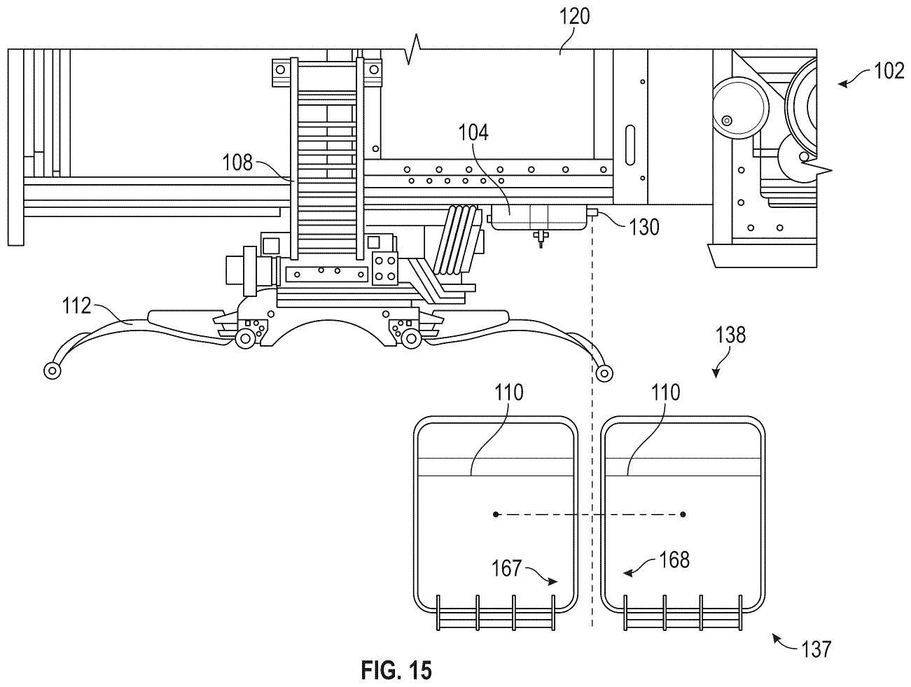

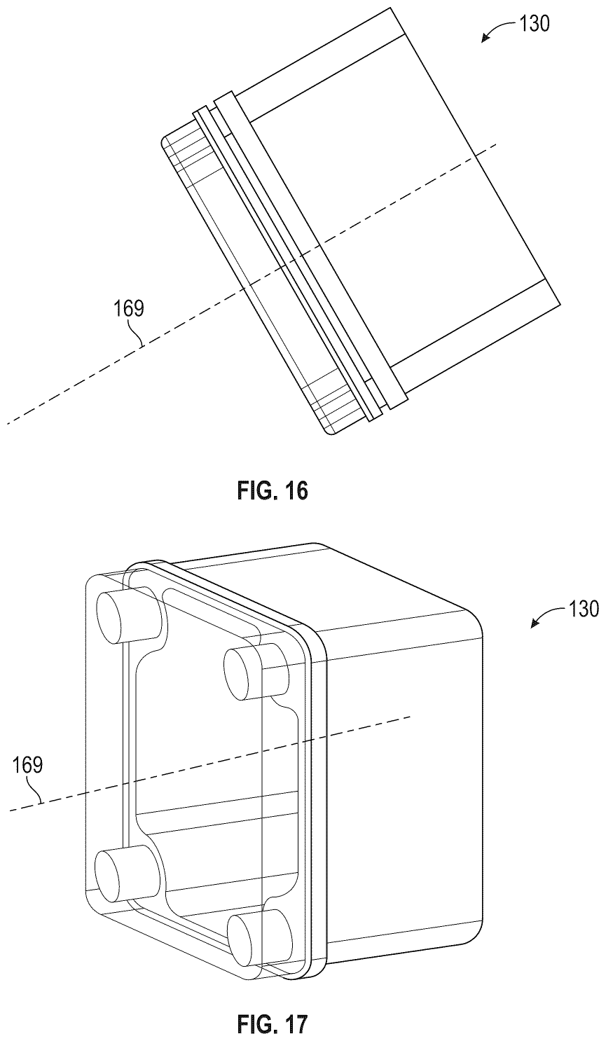

In various embodiments, after the first position has been confirmed in the step 915, one or more edge detection operations can be carried out in a step 917 to determine a lateral detection range (i.e., in a direction parallel to a length of the vehicle 102) of the at least one sensor 130. For example, as shown in FIG. 15, with the receptacle 110 placed in the first position (i.e., at a first perpendicular distance 140 from the head frame 120), the receptacle 110 can be displaced to a first lateral location such that a sensing line of the at least one proximity sensor 130 is aligned with or past a first side 167 of the receptacle 110 (i.e., so the receptacle 110 is no longer in line with the at least one sensor 130). For example, as shown in FIGS. 16-17, the at least one proximity sensor 130 can be configured to sense proximity along a line/axis 169. Accordingly, shifting the receptacle 110 to a lateral location (e.g., first lateral location or second lateral location) can offset the receptacle 110 from the line 169. Once in the first lateral location, the at least one controller 155 can be used to confirm a first edge detection is complete. Similarly, the receptacle 110 can be displaced to a second lateral location such that a sensing line of the at least one proximity sensor 130 is aligned with or past a second side 168 of the receptacle 110 (i.e., so the receptacle 110 is no longer in line with the at least one sensor 130). Once in the second lateral location, the at least one controller 155 can be used to confirm a second edge detection is complete. In various embodiments, at least one of the button 160 or the button 165 can be used to confirm the first or second edge detection is complete.

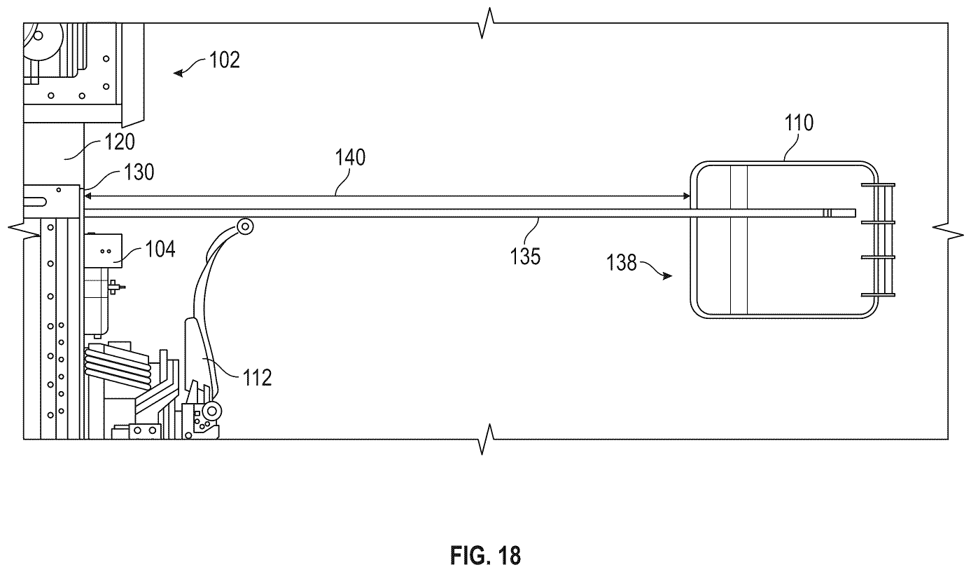

In a step 920, the receptacle 110 can be placed in a second position, as shown in FIG. 18. In various embodiments, when the receptacle 110 is in the second position, the front edge 138 of the receptacle 110 is disposed a second perpendicular distance 140 from the head frame 120. In various embodiments, when the receptacle 100 is in the second position, the sensing line of the at least one proximity sensor 130 is aligned with or past the first side 167. In some embodiments, the second perpendicular distance 140 is greater than the first perpendicular distance 140 (i.e., when the receptacle 110 is in the first position). In various embodiments, the second perpendicular distance is approximately 100 inches. Once the receptacle 110 is in the second position, the distance 140 can be confirmed (i.e., measured by the at least one sensor 130) and stored by the control system 410. In some embodiments, confirming the receptacle 110 is in the second position can be carried out via the at least one controller. For example, in some embodiments, a user can press one of the first button 160 or the second button 165 on the controller 155 that the receptacle 110 is in the second position. In various embodiments, the step 917 can be repeated to determine lateral edge detection limits of the at least one sensor 130 when the receptacle 110 is in the second position.

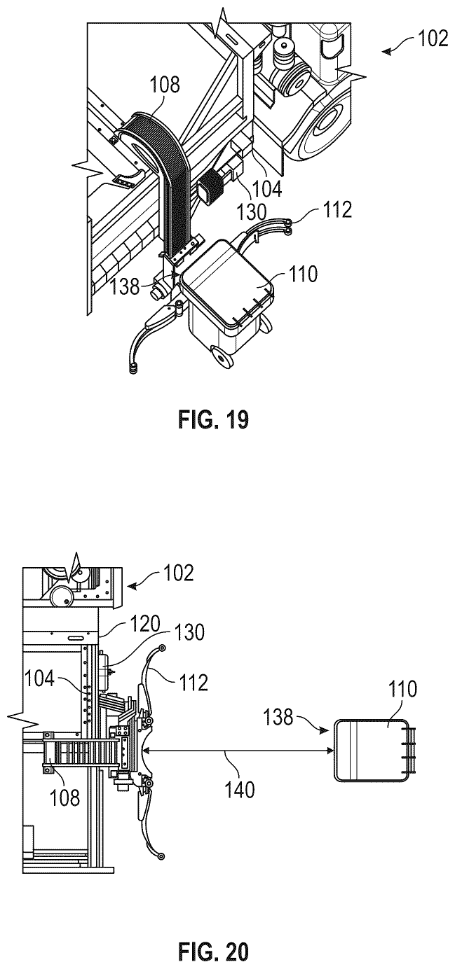

In a step 925, the receptacle 110 can be placed in a third position having a third distance 140 between the receptacle 110 and the vehicle 102. In some embodiments, the third distance 140 (i.e., defined as a perpendicular distance from the front edge 138 to the vehicle 120) is approximately zero. In other embodiments, as shown in FIG. 19, when the receptacle 110 is in the third position, the front edge 138 of the receptacle 110 is disposed adjacent to the grasping mechanism 112. In various embodiments, the receptacle 110 is laterally centered between outer ends of the grasping mechanism 112. Once the receptacle 110 is in the third position, the third distance 140 can be confirmed (i.e., measured by the at least one sensor 130) and stored by the control system 410. In some embodiments, confirming the receptacle 110 is in the third position can be carried out via the at least one controller. For example, in some embodiments, a user can press one of the first button 160 or the second button 165 on the controller 155 that the receptacle 110 is in the third position. In various embodiments, the step 917 can be repeated to determine lateral edge detection limits of the at least one sensor 130 when the receptacle 110 is in the third position.

In a step 930, the receptacle 110 can be placed in a fourth position having a fourth distance 140 (i.e., defined as a perpendicular distance from the front edge 138) between the receptacle 110 and a front edge of the grasping mechanism 112. In some embodiments, the fourth distance 140 is approximately 78 inches. In some embodiments, as shown in FIG. 20, when the receptacle 110 is in the fourth position, the receptacle 110 can be laterally centered between outer ends of the grasping mechanism 112. Accordingly, when the receptacle 110 is in the fourth position, the fourth distance 140 is greater than the third distance 140, where the receptacle 110 is in a same lateral position as when in the third position. Once the receptacle 110 is in the fourth position, the fourth distance 140 can be confirmed (i.e., measured by the at least one sensor 130) and stored by the control system 410. In some embodiments, confirming the receptacle 110 is in the fourth position can be carried out via the at least one controller. For example, in some embodiments, a user can press one of the first button 160 or the second button 165 on the controller 155 that the receptacle 110 is in the fourth position. In various embodiments, the step 917 can be repeated to determine lateral edge detection limits of the at least one sensor 130 when the receptacle 110 is in the fourth position.

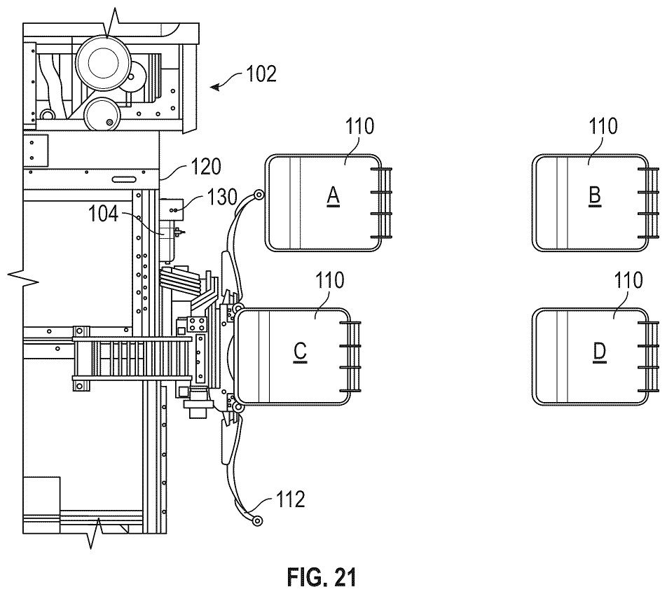

Finally, after the step 930 has been completed, calibration setup of the system 100 can be verified in the step 935. In various embodiments, verification can be carried out by placing the receptacle 110 into each of the first, second, third, and fourth positions and verifying (i.e., via the control system 410) the distance 140 measured by the at least one sensor 130 is accurate. FIG. 21 shows a schematic representation of the receptacle 110 in each of the first position (denoted with “A”), the second position (denoted with “B”), the third position (denoted with “C”), and the fourth position (“D”). In various embodiments, the receptacle 110 can be returned to the first position and sequentially repositioned to each of the second, third, and fourth positions. In other embodiments, the receptacle 110 can be repositioned in reverse order, such that the fourth position is verified, followed by the third, second, and first positions. In yet other embodiments, step 935 can be carried out by randomly repositioning the receptacle 110 into each of the first, second, third, and fourth positions. In various embodiments, in between positioning the receptacle 110 into each of the first, second, third, and fourth positions, the controller 410 can be further configured to verify lateral edge detection limits of the at least one sensor 130. In some embodiments, the step 935 can further include displacing the receptacle in a direction perpendicular to the vehicle 120 (i.e., so the distance 140 changes) to verify the measured distance 140 is registered and the arm 108 can reposition and collect the receptacle 110. In various embodiments, if the control system 410 determines in the step 935 that the distance 140 for any of the first, second, third, or fourth position is inaccurate, the control system 410 can be configured to repeat the method 900.

In various embodiments, the method 900 can be carried out by the control system 410 when the vehicle enters service or following maintenance/repairs. In other embodiments, the method 900 can be carried out by the control system 410 periodically to maintain appropriate operation of the system 100.

Notwithstanding the embodiments described above in FIGS. 1-21, various modifications and inclusions to those embodiments are contemplated and considered within the scope of the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM,

EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claim.

What is claimed is:

1. A control system for a refuse vehicle, the system comprising:
at least one proximity sensor configured to sense a proximity of a target waste receptacle positioned relative to a lift apparatus of the refuse vehicle; and
processing circuitry configured to:
register a perpendicular distance between an edge of the target waste receptacle and a portion of the refuse vehicle;
register a first lateral location of the target waste receptacle when the target waste receptacle is at the perpendicular distance;
register a second lateral location of the target waste receptacle when the target waste receptacle is at the perpendicular distance;
define a sensing range based on the first lateral location and the second lateral location;
store the perpendicular distance and the sensing range in a memory; and
repeat registering the perpendicular distance, the first lateral location, and the second lateral location for each of a first position, second position, third position, and fourth position of the target waste receptacle.

2. The control system of claim 1, wherein the at least one proximity sensor is a light detection and ranging (LiDAR) sensor.

3. The control system of claim 1, wherein the perpendicular distance corresponding to the first position is 30 inches.

4. The control system of claim 1, wherein the perpendicular distance corresponding to the second position is 100 inches.

5. The control system of claim 1, wherein the perpendicular distance corresponding to the third position is zero inches.

6. The control system of claim 1 wherein the perpendicular distance corresponding to the fourth position is 78 inches.

7. The control system of claim 1, wherein processing circuitry is further configured to initiate registering the perpendicular distance between an edge of the target waste receptacle and a portion of the refuse vehicle responsive to an input received from at least one controller within the refuse vehicle.

8. The control system of claim 7, wherein the input corresponds to a calibration procedure.

9. A refuse vehicle comprising:
an arm structured to collect a waste receptacle;
at least one sensor structured to sense a proximity of the waste receptacle; and
at least one processor communicatively coupled to the arm and the at least one sensor, the at least one processor configured to carry out a calibration setup, wherein carrying out the calibration setup comprises:
registering a perpendicular distance between an edge of the waste receptacle and a portion of the refuse vehicle;
registering a first lateral location of the waste receptacle when the waste receptacle is at the perpendicular distance;
registering a second lateral location of the waste receptacle when the waste receptacle is at the perpendicular distance;
defining a sensing range based on the first lateral location and the second lateral location;
storing the perpendicular distance and the sensing range in a memory; and
repeating registering the perpendicular distance, the first lateral location, and the second lateral location for a plurality of positions corresponding to the waste receptacle.

10. The refuse vehicle of claim 9, wherein the plurality of positions comprises four predetermined positions.

11. The refuse vehicle of claim 10, wherein each of the first lateral location and the second lateral location are determined in a direction parallel to a length of the refuse vehicle.

12. The refuse vehicle of claim 11, wherein when the waste receptacle is in a first position of the four predetermined positions, a sensing line of the at least one sensor is aligned with a first side of the waste receptacle.

13. The refuse vehicle of claim 11, wherein when the waste receptacle is in a second position of the four predetermined positions, the sensing line of the at least one sensor is aligned with a first side of the waste receptacle; and
wherein the perpendicular distance at the first position is smaller than the perpendicular distance at the second position.

14. The refuse vehicle of claim 13, further comprising a grasping mechanism coupled to the arm; and
wherein when the waste receptacle is in a third position of the four predetermined positions, a front end of the waste receptacle is disposed adjacent to the grasping mechanism.

15. The refuse vehicle of claim 14, wherein when the waste receptacle is in the third position, the waste receptacle is laterally centered between outer ends of the grasping mechanism.

16. The refuse vehicle claim 15, wherein when the waste receptacle is in a fourth position of the four predetermined positions, the waste receptacle is laterally centered between ends of the grasping mechanism.

17. The refuse vehicle of claim 9, wherein the at least one processor is further configured to determine a pick-up zone corresponding to the waste receptacle based on the calibration setup.

18. The refuse vehicle of claim 9, further comprising at least one controller, wherein registering the perpendicular distance, the first lateral location, and the second lateral location for a plurality of positions corresponding to the waste receptacle are carried out via the at least one controller.

19. The refuse vehicle of claim 18, wherein the at least one controller is a joystick.

20. The refuse vehicle of claim 9, wherein the at least one sensor is a light detection and ranging (LiDAR) sensor.
